(19) United States
(12) Patent Application Publication
(10) Pub. No.: US 2023/0049570 A1
(43) Pub. Date: Feb. 16, 2023

(54) Smart Sound Appliance

(71) Applicant: Scott C Harris, San Diego, CA (US)

(72) Inventor: Scott C Harris, San Diego, CA (US)

(21) Appl. No.: 17/444,869

(22) Filed: Aug. 11, 2021

(51) Int. Cl. F25B 49/02; H04W 4/80; F04B 49/06

(52) U.S. Cl. CPC F25B 49/022; H04W 4/80; F04B 49/065; F04B 2203/0211; F04B 2207/00; F25B 2500/12

(57) ABSTRACT

A smart sound appliance which has a noise producing device such as a compressor that is controlled by a controller. The controller receives information from a user indicative of whether the user is in a location to receive those sounds. When the user is in the location to receive those sounds, the controller can take an action to reduce those sounds by either turning off the compressor, or reducing the sound of the appliance in some other way.

### BACKGROUND

Appliances carry out various functions in our daily life. Operation of such appliances often create sounds and noise as part of carrying out these functions based on their motors/compressors and other electrically powered parts.

Manufacturers have attempted to make low noise appliances, by soundproofing them and using lower noise motors and components. However, there are often limits and trade-offs in the amount of noise that can be reduced.

### SUMMARY OF THE INVENTION

An inventor recognized that sounds from appliances are only a problem when a user is close enough to hear the noise. When the user is out of the house or in a different room, the sound the appliance makes is often of no consequence.

An embodiment describes a smart sound appliance that detects a proximity of the user and automatically adjusts its sound output based on the user proximity.

In embodiments, the appliance can be preferentially on when there are no users in the room, or during a time period when it is more likely that there will be no users in the room.

In another embodiment, the appliance can use a variable speed electromotive device, which can be driven at a higher level when the user is in the room and at a less high-level when the user is distant.

### BRIEF DESCRIPTION OF THE DRAWINGS

In the Drawings:

FIG. 1 shows a block diagram of the system;

FIG. 2 shows a flowchart of operations;

FIG. 3 shows a flowchart of adjusting the aggressiveness of the sound reduction; and

FIG. 4 shows a flowchart of a learning embodiment with advanced timing operations.

### DETAILED DESCRIPTION

The present application describes a smart sound appliance. This can be part of or applied to any appliance which creates sound during the times that it is operating to carry out its appliance function. In one embodiment, the smart sound appliance can be a refrigerator. In other embodiments, however, the smart sound appliance can be a washer dryer, dishwasher, pool driving equipment, or any other sound producing device. Many of these devices we use pumps, or pumps which are configured to create cooling, in the form of a compressor.

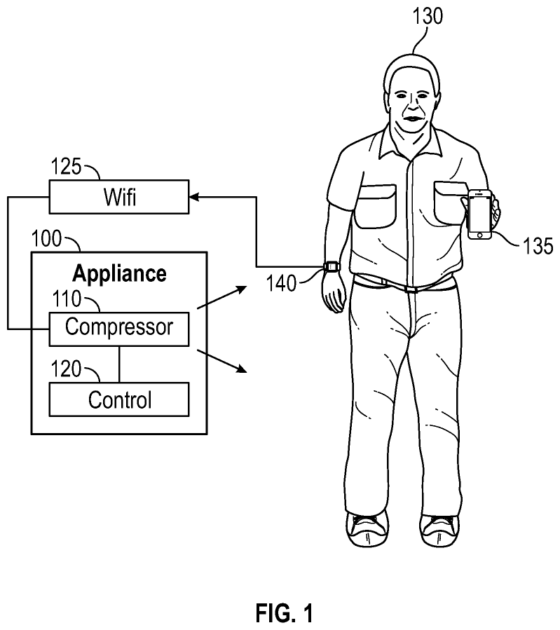

In an embodiment, the appliance 100, which is shown herein as a refrigerator, but can be any of the other appliances, is shown in FIG. 1. The appliance has a compressor 110 which is driven by a control mechanism 120. The control mechanism 120 may be for example a controlling board. The appliance also connects to a network connection, here shown as wifi 125, although this could also be Bluetooth or any other networked or remotely controllable connection. The user 130 is also shown. Users conventionally have their own set of devices. The user 130 is shown having a phone 135, and also having a watch 140. The watch 140 can be a smart watch. Users can also have other devices, such as Bluetooth headsets, or any other device which communicates wirelessly.

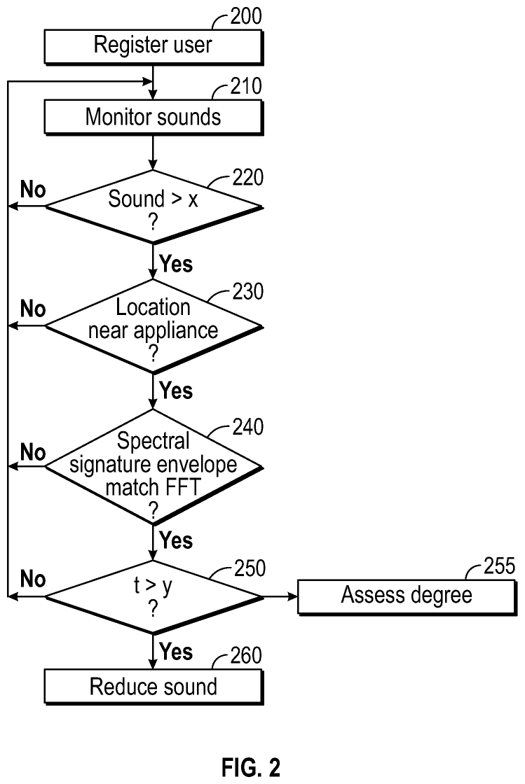

The controller 120 can operate according to the flowchart of FIG. 2. At 200, the user registers with the system. This can be done, for example, by the user downloading an app, and communicating with the controller. It can alternatively include the controller hosting a local Wi-Fi network, which can be connected to by the user in order to log into the system.

The user may have to scan a code such as a QR code or serial number code from the device. There are numerous ways to connect to smart appliances, and any of these are intended to be encompassed within the user registration function 200.

Once the user is registered, at 210, their personal device(s), e.g., 135, 140 or other devices being worn, are used to monitor ambient sounds. The sound is monitored by the microphone of the phone, watch, or headset. Rather than continual monitoring, this may monitor, for example, 0.25 seconds of sound, every 10 seconds to sample the sound level.

The ambient sounds of interest, are those of the type created by the appliance, greater than a sound threshold level x, for a time period y, and optionally while the device is in the location z close to the appliance as sensed at 220. A number of tests are shown in FIG. 2, but it should be understood that any of the tests being positive in FIG. 2, any or all of 220, 230, 240, 250, can give rise to the command to reduce the appliance sound at 260.

In one embodiment, the device's proximity to the appliance is detected at 230. This can be done by using conventional location detection techniques such as GPS. It can also be detected by determining whether the device is within Bluetooth connection range of the appliance. In any of these scenarios, this establishes the device as being in location z, for example, within 25-50 feet of the appliance.

In this embodiment, if the sound is greater than x, for the time period, then actions are taken at 225 to reduce the sound of the appliance, as described herein.

In an embodiment, an advanced analysis of sound is carried out at 240 to make it more certain that the sound that is being received is actually from the appliance. The sound is analyzed to carry out a spectral analysis of the sound, and to compare the sound with a spectral signature of the kinds of sounds that the device makes. This can be done in different ways in different embodiments. In one embodiment, an envelope of the sound created by the appliance is stored as a sample. An envelope of the local sound is also taken, and the envelopes can be compared.

In another embodiment, a fast Fourier transform of the sound is taken, to convert the sound signal into information indicative of its individual spectral components. These individual spectral components are compared with a similar fast Fourier transform (FFT) of a sound conventionally created by the appliance. In one embodiment the fast Fourier transform can be converted to a feature vector that represents different amounts of energy in different spectral components of the signal. In another embodiment, a numerical score can be formed to characterize the sound and the different kinds of frequencies that are in the sound. 240 determines whether the character of the sound is similar enough to the the appliance. If not, flow returns to 210 to continue to monitor the sounds.

If the spectral test at 240 is positive, then 250 determines if the sound has continued for a time period greater than the threshold why, for example 10 to 15 seconds. This may take for example 2-5 consecutive samples to determine whether the sound has been created for the requisite amount of time.

If the sound has been created for the necessary period of time, then action is taken at 260 reduce the sound.

It should be understood that any or all of the tests in FIG. 2 can be used to determine that the sound should be reduced. For example, just detecting the user near the appliance can be used in one embodiment, and just detecting the spectral signature match can be used in another embodiment.

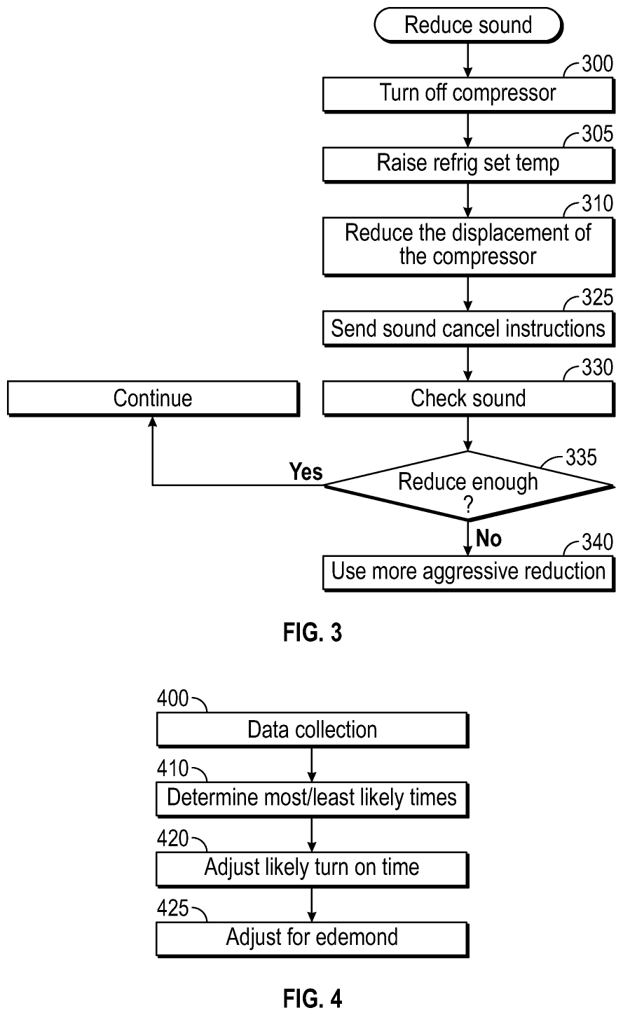

The sound reducing action routine is shown in FIG. 3. Sound reduction can be carried out in different ways and with different levels of aggressiveness.

The simplest sound reduction, shown at 300, is a carrying out of an action to turn off the compressor. In one embodiment, for example for the embodiment of the appliance 100 being a refrigerator or freezer, the temperature limit can be temporarily raised during the time when the user is in the location close to the refrigerator, shown as 302.

For example, in a refrigerator, the refrigerator may be set to 35°. However, during times of sound reduction, the limit may be temporarily set to a higher level such as 40°. This causes the compressor to be turned off because of the raising of the temperature. The temperature is maintained at that higher level until the user is no longer in the location where they can hear the sounds.

In other embodiments, the compressor can simply be turned off for a specified time period, e.g. for 30 minutes or one hour, or some other amount of time which can be decided by the manufacturer as an amount of time that will not be likely to affect the temperature of the items in the refrigerator.

Another way to reduce the temperature or the sound is shown at 310 in an appliance which uses a variable displacement compressor. This may be for example in a smart refrigerator that uses a smart compressor, or in an air conditioning system. This may be used also in combination with the subject matter step 302, that raises the temperature limit. At 310, the displacement of the compressor can be lowered which can be done in addition to or as an alternative to the other options that can be carried out. Typically, displacements of the unit, or more generally the speed of the fan, is reduced to reduce the sound created by the fan.

In another embodiment shown as 320, the system can send a sound canceling instruction to smart headphones to take an action to cancel or reduce the effect of the sound. For example, this can send an audio file, that can include sound canceling information that can be played by the headphones to help deaden the sound. Again this can be done in addition to the other sound reducing options. At 330, the sound is checked, by checking the sound from the user's phone. If the sound has not been reduced sufficiently at 340 then additional steps may be taken to reduce the sound, such as operating an additional one of the sound reducing steps. Once the sound is been sufficiently reduced, the sound reducing step may continue for a time period, e.g., such as 30 minutes, or in another embodiment until step 230 indicates that the user is no longer near the appliance.

In an alternative embodiment, shown in step 255, after determining that the sound should be reduced, the degree of aggressiveness of reducing the sound is determined. The sounds and/or the location are monitored to determine if the user is close, intermediate, or far from the appliance, to determine the degree of aggressiveness to use in driving the appliance to to reduce its sound. **

Another embodiment, shown in FIG. 4, collects the data indicative of when the user is close to an in range of the appliance. In an embodiment, the data collection at 400 can include any of the elements from FIG. 2, whether the sound is greater than X, at 220, whether the user is near the appliance at 230, the spectral envelope match at 240, the time which the sounds occur, at 250, and the degree of sound at 255. This is collected as a function of time of day. The system assesses the data collection to determine as a percentage wise, when the user is likely to be near the appliance in a way that the sounds of the appliance would bother the user. From this, the system can determine at 410 the most likely times when the user is likely to be near the city device and the least likely times when the user is less likely to be near the device. The system can in this case make it less likely that the system will turn on during the more likely times and less likely that the system will turn on during the least likely times this is adjusted at 420, by changing for example a threshold of when the system turns on.

For example, the user is likely to be in the room between 6 and 8. Preferentially, turn on the device between 4 and 6, and run at full blast during that time. Then, you can run it less aggressively between 6 and 8. Alternatively, the system can be run less aggressively between 6 PM and 8 PM, and turned on more aggressively after 8 PM.

The less of aggressive system can be caused by increasing the temperature limit, or decreasing the amount of power used by the system to try and attain that temperature limit.

System can also do this for periods of high electric output. For example, in the summertime, the system can say I don't want to run the electricity the refrigerator as aggressively between 4 and 9 PM. So run it between 3 and 4 at full aggression, and then turn it on again at 9 PM. But if the user's in the room at 9 PM on turn on lately at 9 PM knowing I'll be able to turn it on by 11 PM.

At 425, the likelihood chart that was created of 420 is adjusted for electrical demand. For example, hours of maximum electrical demand can be either electronically received from the utility, or can be set. Many times, maximum electric demand is between 4 and 9 PM. The likelihood of turn on can be even further reduced during times of maximum electric demand and increased during times of minimal electric demand.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. For example, while the above describes using QR codes, it should be understood that other codes can be scanned, or other ways of obtaining the information can be scanned into the phone. Thus, the present invention is not intended to be limited to the embodiments shown herein but is to be accorded the widest scope consistent with the principles and novel features disclosed herein.

What is claimed is:

1. A smart sound appliance, comprising:
an appliance, which operates to carry out an appliance function, where the appliance creates sounds during its carrying out its appliance function;
a controller, associated with the appliance, which controls and operation of the appliance, the controller receiving an indication from a remote user indicating that the remote user is in a location likely to receive the sounds created during carrying out the appliance function, and automatically operating to reduce the sound output responsive to detecting that the remote user is in the location.

2. The appliance as in claim one, wherein the controller receives the indication from a personal device associated with the user.

3. The appliance as in claim 2, wherein the personal device is at least one of a cellular phone or a smart watch.

4. The appliance as in claim 3, wherein the indication includes a sound received by the cellular phone or smart watch.

5. The appliance as in claim 4, wherein the controller operates to obtain a spectral signature of the sound, and determine if the sound is one likely to be associated with the appliance from the spectral signature.

6. The appliance as in claim 3, wherein the indication includes a location detected by the phone and/or smart watch.

7. The appliance as in claim 2 wherein the indication includes information about a spectral signature of the sound being received by the personal device.

8. The appliance as in claim 1, wherein the controller receives information about a degree of the sound, and determines an amount of aggressiveness to use in reducing the sound.

9. The appliance as in claim 1, wherein after reducing the sound, the controller receives information indicative of whether the sound has been reduced by an amount, and increases and aggressiveness of sound reduction if the sound has not been reduced by the amount.

10. The appliance as in claim 1, wherein the controller collects data indicative of times when the user is most likely to be in the location to receive the sounds, and adjusts the likelihood of operating the controller at different times, based on the data indicative of the times.

11. A method of operating an appliance, comprising:
using a controller to operate an appliance, which operates to carry out an appliance function, where the appliance creates sounds during carrying out its appliance function; and
receiving an indication from a remote user indicating that the remote user is in a location likely to receive the sounds created during carrying out the appliance function, and automatically operating to reduce the sound output responsive to detecting that the remote user is in the location.

12. The method as in claim 11, wherein the receiving comprises receiving the indication from a personal device associated with the user.

13. The method as in claim 12, wherein the personal device is at least one of a cellular phone or a smart watch.

14. The method as in claim 13, wherein the indication includes a sound received by the cellular phone or smart watch.

15. The method as in claim 14, further comprising obtaining a spectral signature of the sound, and determine if the sound is one likely to be associated with the method from the spectral signature.

16. The method as in claim 13, wherein the indication includes a location detected by the phone and/or smart watch.

17. The method as in claim 11, further comprising receiving information about a degree of the sound, and using the information about the degree of the sound to determine an amount of aggressiveness to use in reducing the sound.

18. The method as in claim 11, wherein after reducing the sound, further comprising receiving information indicative of whether the sound has been reduced by an amount, and increasing an aggressiveness of sound reduction if the sound has not been reduced by the amount.

19. The method as in claim 11, further comprising collecting data indicative of times when the user is most likely to be in the location to receive the sounds, and adjusting a likelihood of operating the controller at different times, based on the data indicative of the times.
